(19) United States
(12) Patent Application Publication
(10) Pub. No.: US 2026/0347197 A1
(43) Pub. Date: Nov. 5, 2026

(54) HOLLOW SILICA AEROGELS AND METHODS THEREOF

(71) Applicant: University of Maryland, College Park, College Park, MD (US)

(72) Inventors: Shenqiang Ren, College Park, MD (US); Taotao Meng, College Park, MD (US)

(21) Appl. No.: 19/665,305

(22) Filed: May 1, 2026

Related U.S. Application Data
(60) Provisional application No. 63/799,034, filed on May 2, 2025.

(51) Int. Cl. C01B 33/158

(52) U.S. Cl. CPC C01B 33/1585; C01P 2004/03; C01P 2004/04; C01P 2004/34; C01P 2004/61; C01P 2006/10

(57) ABSTRACT

This present disclosure is directed to production of tunable hollow silica aerogel spheres utilizing soft bubble templating.

### CROSS REFERENCE TO RELATED APPLICATIONS

This application claims priority to U.S. Application No. 63/799,034, filed on May 2, 2025, the contents of which are hereby incorporated by reference in its entirety.

### STATEMENT OF FEDERALLY SPONSORED RESEARCH AND DEVELOPMENT

This invention was made with government support under DE-AR0001771 awarded by the U.S. Department of Energy. The government has certain rights in the invention.

### FIELD OF THE INVENTION

The field of the invention relates generally to production of tunable hollow silica aerogel spheres utilizing soft bubble templating.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Silica aerogels have emerged as promising candidates for advanced insulation applications due to their exceptional material properties, such as high porosity, large specific surface area, and customizable synthesis. These ultralight, highly porous solids exhibit an extraordinary porosity often exceeding 90% and a correspondingly low density, granting them unparalleled thermal insulation capabilities that surpass conventional insulation materials. Additionally, silica aerogels possess high-temperature resistance and inherent fire-retardant characteristics, making them versatile for use in diverse applications ranging from industrial thermal management to building insulation and aerospace engineering.

The sol-gel method is the most commonly employed technique for silica aerogel synthesis, offering significant advantages in tailoring material properties. This method involves the hydrolysis and condensation of silica precursors, such as tetraethyl orthosilicate (TEOS) or sodium silicate, to form a wet gel with a highly porous network structure. The sol-gel approach is valued for its versatility, as process parameters such as pH, solvent ratios, and reaction catalysts can be adjusted to achieve specific porosity, density, and surface area requirements. Additionally, it enables the production of silica aerogels with excellent thermal insulation properties and high specific surface areas, making it a cornerstone technique for aerogel fabrication. However, the sol-gel method is not without its limitations.

The practical deployment of SiO₂ aerogel has been hindered by its high manufacturing costs and low production efficiency. Previous conventional methods use solid spheres made of polymers such as polystyrene or PVP as a template, and then create a shell using an amalgamation of individual silica particles, which result in inconsistent pinholes and high thermal conductivity.

One major drawback is the requirement for supercritical drying to preserve the delicate gel structure and prevent pore collapse. This step is highly energy-intensive and contributes significantly to production costs. Alternative drying methods, such as ambient pressure drying (APD), often involve surface modification but can compromise pore structure integrity or require prolonged processing times. Furthermore, the sol-gel process is highly sensitive to environmental factors, such as temperature and humidity, which can affect the consistency and scalability of the final product. Despite these limitations, several studies have explored innovations to enhance the sol-gel process. For instance, modified sol-gel approaches incorporating surfactants or template materials have been investigated to improve structural control and reduce drying constraints. Similarly, hybrid techniques combining sol-gel chemistry with freeze-drying or ambient pressure drying have shown promise in reducing energy consumption while retaining desirable material properties. Despite these advancements, the widespread commercial adoption of silica aerogels remains hindered by the cost and scalability challenges associated with traditional sol-gel synthesis.

Therefore, there still remains a need for cost effective silica aerogels that can be scaled up for commercial utilization.

### SUMMARY

One aspect of the invention pertains to a hollow silica material. The material comprises hollow spherical particles, where the particles are in the form of microspheres. The material is free of nanoporous silica particles and polymers such as PVP or polystyrene.

A further aspect of the invention pertains to a method of making the hollow silica material disclosed herein. The method of preparing the hollow silica particles comprises the use of bubble templates.

A further aspect of the invention pertains to method of the invention pertains to an insulation material. The insulation material comprises the hollow silica material disclosed herein.

A further aspect of the invention pertains to a battery comprising a hollow silica material disclosed herein. An exemplary embodiment of this aspect of the invention can be seen in FIGS. 5A and 5B.

This work addresses the aforementioned limitations by developing a novel soft bubble-template method to enable cost-effective, scalable production of tunable SiO₂ hollow spheres. The key innovation is a rapid 20-minute gelation process that can be carried out under ambient temperature and pressure conditions. By systematically investigating the effects of synthesis chemicals on the hollow sphere structure and performance, an optimized formulation was achieved, ensuring efficient and reliable production. The resulting SiO₂ hollow spheres demonstrate impressive thermal insulation performance, with a thermal conductivity as low as 15 mW m⁻¹ K⁻¹ and an exceptionally high porosity exceeding 98%, outperforming many commercial aerogel products. Their high porosity and tailored void structure contribute to this excellent thermal insulation. Notably, the production process features significant environmental benefits, with a remarkably low carbon footprint of 17.07 kg CO₂/kg and a high production yield of up to 40%, achieving an excellent balance between performance and environmental benefits. This soft bubble-template approach represents a significant advance that could help transition SiO₂ hollow sphere technology from the lab to large-scale industrial applications as high-performance, cost-effective thermal insulation materials.

This work addresses these critical limitations by developing a novel soft-template method for the cost-effective, scalable production of silica hollow spheres with exceptional insulation performance and a low environmental impact. The proposed approach enables rapid gelation under ambient conditions within just 10 minutes, overcoming the processing constraints of traditional aerogel synthesis. The resulting material demonstrates an ultralow thermal conductivity of 15 mW·m⁻¹·K⁻¹, a porosity exceeding 98%, and a significantly reduced carbon footprint, paving the way for the large-scale industrial adoption of silica-based insulation solutions.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1 Synthesis and characterizations of hollow silica via bubble template. FIG. 1A) Schematic illustration of the synthesis of hollow silica. FIG. 1B) Digital photograph of hollow silica gel of about 5 L. FIG. 1C) Comparison of the synthesis time between this method and the other template type of hollow silica. FIG. 1D) SEM image of the as-synthesized hollow silica. FIG. 1E) High-magnification SEM images of the single hollow silica particle. FIG. 1F) High-magnification TEM images of the single hollow silica particle. FIG. 1G) Density versus thermal conductivities for these aerogels and other previously reported aerogel materials.

FIG. 2 The composition principle and characterization of hollow silica. (A-D) Digital photographs showing the macroscopic appearance of samples: (FIG. 2A) complete hollow silica with all components, (FIG. 2B) synthesis without CTAB, (FIG. 2C) synthesis without ammonia hydroxide (AH), and (FIG. 2D) synthesis without TMB. (FIG. 2E-2H) SEM images of samples: (FIG. 2E) complete hollow silica with all components shows well-defined hollow spherical structures with uniform morphology, (FIG. 2F) hollow silica synthesis without CTAB shows irregular bulk aggregates without hollow features, (FIG. 2G) hollow silica synthesis without AH shows poorly defined structures due to incomplete hydrolysis, and (FIG. 2H) hollow silica synthesis without AH shows partially formed hollow spheres with compromised structural integrity. (FIG. 2I) Chemical equations illustrating the formation mechanism of silica: hydrolysis of TEOS (Si(OCH2CH3)4) under alkaline conditions to form Si(OH)4, followed by condensation reaction leading to the formation of Si—O—Si network structure. (FIG. 2J) FTIR spectra comparing the chemical composition of samples prepared with different components, highlighting the characteristic peaks of Si—O—Si bonds. (FIG. 2K) XRD patterns of samples demonstrating the amorphous nature of the silica structures, with a characteristic broad peak at 2θ=22°.

FIG. 3 Effects of CTAB/TEOS molar ratio on the pore structure and insulation properties of hollow silica: (FIG. 3A) SEM images of hollow silica microspheres prepared with different CTAB/TEOS molar ratios, showing the evolution of particle morphology; (FIG. 3B) TEM and (FIG. 3C) High-magnification SEM images showing the internal structure and interconnection of hollow silica synthesized at different CTAB/TEOS molar ratios; (FIG. 3D) Porosity of hollow silica via different CTAB/TEOS molar ratio; (FIG. 3E) Density of hollow silica via different CTAB/TEOS molar ratio; (FIG. 3F) Thermal conductivity of hollow silica via different CTAB/TEOS molar ratio.

FIG. 4 Thermal conductivity numerical simulations of hollow silica. (FIG. 4A) Schematic illustration of hollow silica spheres assembly structure showing the arrangement of multiple spheres in contact. (FIG. 4B) Geometric model of two contacting hollow spheres with key parameters labeled (FIG. 4C, 4F) Three-dimensional temperature distribution maps showing heat conduction through the contacting hollow spheres. The color scale represents temperature from 20 °C (blue) to 100 °C (red). (FIG. 4D, 4G) Cross-sectional temperature contours in the y-z plane, demonstrating the temperature gradient across the contact region. Color scale ranges from 20 °C to 100 °C. (FIG. 4E, 4H) Heat flux distribution maps showing the thermal energy transfer patterns. The color scale indicates heat flux intensity from 0 to 6 W/m². (FIG. 4I) Plot of effective thermal conductivity from top surface (k_eff) versus contact length.

FIG. 5 Battery thermal management. (FIG. 5A) Schematic diagram of a battery wrapped in an insulation composite, reducing thermal dissipation and improving safety. (FIG. 5B) Photograph of a battery wrapped in a silica-ceramic fiber composite for thermal insulation. (FIG. 5C) Discharge voltage curves of batteries wrapped in silica-ceramic fiber, pure ceramic fiber, and without insulation, showing improved performance with silica-ceramic fiber. (FIG. 5D) Thermal infrared images comparing the temperature evolution of silica-ceramic fiber and pure ceramic fiber under heating at different time intervals (0 s, 30 s, 60 s, 90 s, 120 s, 150 s, and 180 s). (FIG. 5E) Temperature variation (ΔT) over time for silica-ceramic fiber and pure ceramic fiber composites, showing the thermal insulation effect. (FIG. 5F) Flame resistance test of the silica-ceramic fiber composite, showing ignition at 1000 °C, burning for 10 seconds, and self-extinguishing behavior.

FIG. 6 Environmental impact and yield analysis of hollow silica: (FIG. 6A) Carbon footprint (kg CO2/kg) of hollow silica microspheres prepared with different CTAB/TEOS mass ratios (FIG. 6B) Linear relationship between final product weight and TEOS volume, demonstrating a consistent production yield across different TEOS concentrations.

FIG. 7 (FIG. 7A) Photo of the synthetic steps of hollow silica formation. (FIGS. 7B and 7C) photo of silica slurry. (FIG. 7D) Photo of silica gel. (FIG. 7E) photo of silica gel.

FIG. 8 (FIG. 8A-FIG. 8D) SEM images showing surface morphology with CTAB amounts of 0.9375 g, 1.875 g, 2.185 g, and 3.75 g; (FIG. 8E-8H) TEM images revealing internal structure with corresponding CTAB amounts; (FIG. 8I) FTIR spectra; (FIG. 8J) XRD patterns; (FIG. 8K) Porosity variations; and (FIG. 8L) Thermal conductivity changes with different CTAB amounts.

Particular non-limiting embodiments of the present invention will now be described with reference to accompanying drawings.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

The term “hollow silica material” as used herein is used interchangeably herein with the term “hollow silica” to refer a silica material comprising hollow spherical silica particles arranged in a network. The hollow spherical silica particles are determined to be hollow by SEM and TEM imaging. In some embodiments, the silica is in the form of microparticles and is opaque. In some embodiments, said hollow silica aerogel is free of nanoporous silica particles.

The term “insulation material” as used herein refers to a substance that reduces or stops the transmission of heat, cold, sound, and/or electricity.

The term “slurry” as used herein refers to a semiliquid mixture of insoluble, or partially soluble fine particles in a solution, such as water. The term “slurry composition” as used herein refers to a composition comprising a composite disclosed herein and water, wherein said water is present in about 70 wt % to about 80 wt %, or about 70 wt % to about 99 wt %.

The term “fire-retardant” as used herein refers to a characteristic of a substance to slow down or stop the spread of fire, or reduce its intensity.

The term “semi-solid gel” as used herein refers to the opaque gel solution of hollow silica materials.

The term “hollow sphere structure” as used herein refers to a three-dimensional spherical shape that has an empty interior.

The term “templating method” as used herein is used interchangeable with the term “flame-retardant” refers to the method of synthesizing hollow silica using a surfactant template. In some embodiments soft bubble templating is used, using surfactant micelle templating. Bubble templating is done by surfactant foaming to produce the micron-sized bubble, serving as the template for the silica shell coating

The term “rapid gelation” as used herein refers to the process of a mixture becoming a gel in about 1 minute to about 10 minutes at standard room temperature and pressure.

As used herein, the term “standard room temperature and pressure” refers to temperature of 20 °C (293.15 K, 68 °F) and an absolute pressure of 1 atm (14.696 psi, 101.325 kPa) as set by NIST.

The abbreviation “GCAc” refers to the term “gradient cellulose-aerogel composite” as used herein.

The abbreviation “CTAB” refers to “Cetyltrimethylammonium bromide” as used herein.

The abbreviation “TEOS” refers to “tetraethyl orthosilicate” as used herein.

### LIST OF EMBODIMENTS

The following is a non-limiting list of embodiments of the inventions and is meant to be exemplary:
1. A hollow silica material, said material comprising hollow silica spherical particles, wherein said particles are in the form of microspheres, wherein said material is free of nanoporous silica particles and free of polymers (e.g., PVP and polystyrene).
2. The hollow silica material of embodiment 1, wherein said hollow sphere particles are about 50 μm to about 1200 μm.
3. The hollow silica material of embodiment 1, wherein said hollow sphere particle has a shell thickness of about from 20 nm to 100 nm.
4. The hollow silica material of embodiment 1, wherein said hollow sphere particles have a thermal conductivity of about 10 mW/mK to about 25 mW/mK, or 15 mW/mK.
5. The hollow silica material of embodiment 1, wherein said hollow sphere particles have a density of about 100 kg/m³ to about 800 kg/m³.
6. The hollow silica material of embodiment 1, wherein said hollow sphere particles have a porosity of about 70% to about 98%.
7. The hollow silica material of any of the preceding embodiments, wherein said hollow sphere particles are used as insulation materials.
8. The hollow silica material of any of the preceding embodiment, wherein said material further comprises a surfactant (e.g., SDS or CTAB).
9. A method of making hollow silica material of any of the preceding embodiments, said method comprising preparing the hollow silica particles using bubble templates.
10. The method of embodiment 9, wherein said method comprises:
   a. Combining an aqueous cationic surfactant with a base and methylene to obtain a silica precursor solution;
   b. Bubble templating said silica precursor solution by foaming treatment to obtain a silica slurry;
   c. Adding TEOS, TMOS, or water-glass to said silica slurry to obtain a semi-solid silica gel; and
   d. Drying said semi-solid silica gel until said silica gel solidified into a non-flowing silica gel comprising hollow silica particles.
11. The method of embodiment 10, wherein said surfactant is chosen from cetyltrimethylammonium bromide (CTAB), sodium dodecyl sulfate (SDS), sodium lauryl sulfate (SLS), sodium stearate, benzalkonium chloride (BAC), or cetrimonium chloride.
12. The method of embodiment 10, wherein said base is chosen from ammonia, NaOH, KOH, Na₂CO₃, Ca(OH)₂.
13. The method of embodiment 10, wherein said semi-solid silica gel is dried at room temperature for about 1 minute to about 10 minutes.
14. The method of any of the preceding embodiments, steps (a)-(d), wherein said method occurs in about 1-10 minutes.
15. The method of any of the preceding embodiments, wherein said method produces about 1 L to about 10 L of a silica aerogel solution.
16. The method of any of the preceding embodiments, wherein semi-solid silica gel is formed in less than 10 minutes.
17. The method of any of the preceding embodiments, wherein said method involves one-pot synthesis of said hollow silica particles.
18. An insulation material comprising a material of any of the preceding embodiments.
19. A battery, said battery comprises a material of any of the preceding embodiments.

### EXAMPLES

The following examples are provided solely to illustrate the present invention and are not intended to limit the scope of the invention, described herein.

### Example 1. Synthesis Route

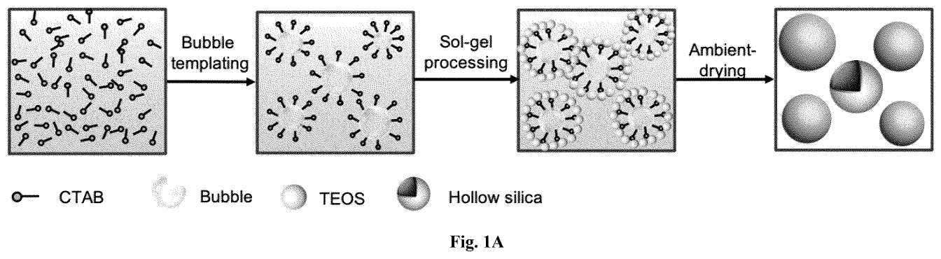

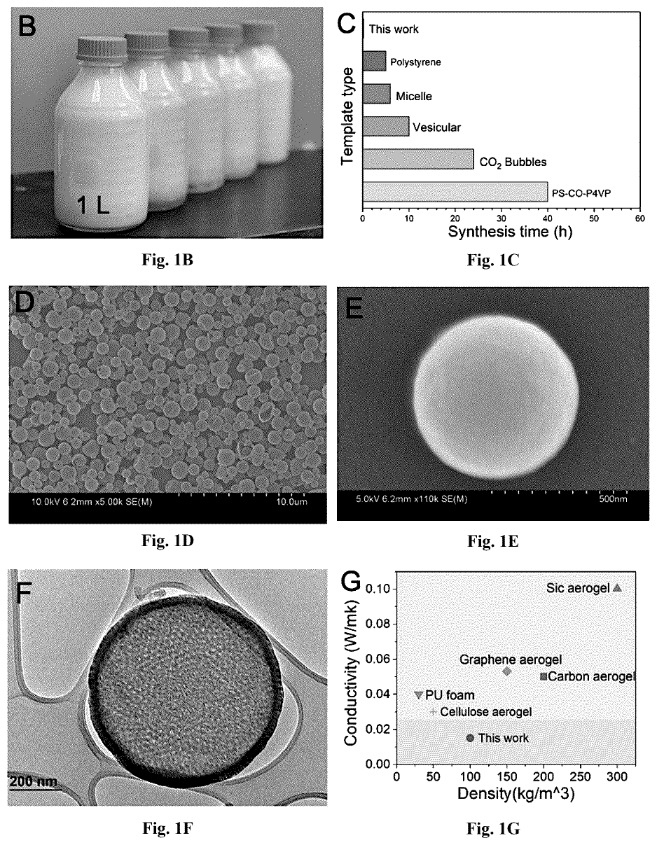

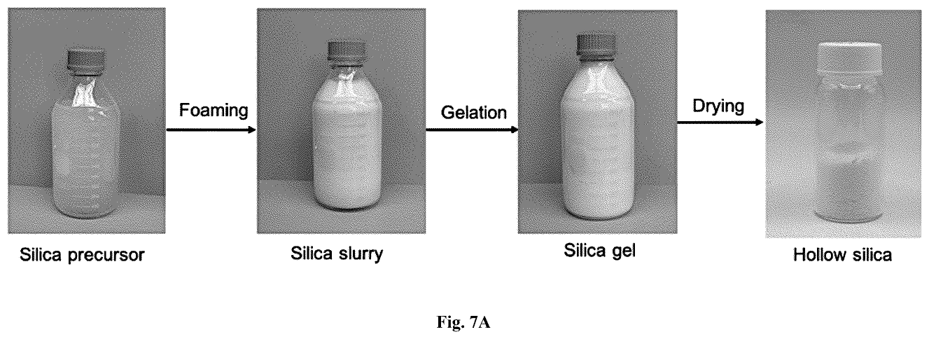

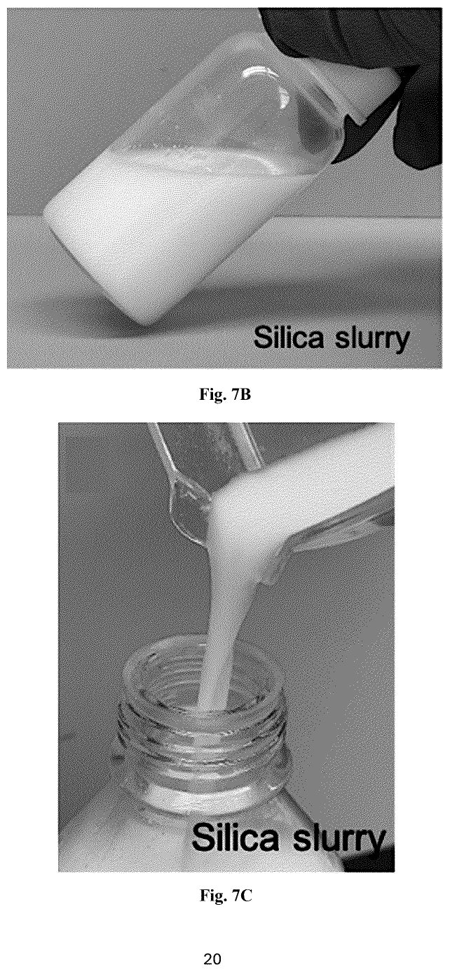

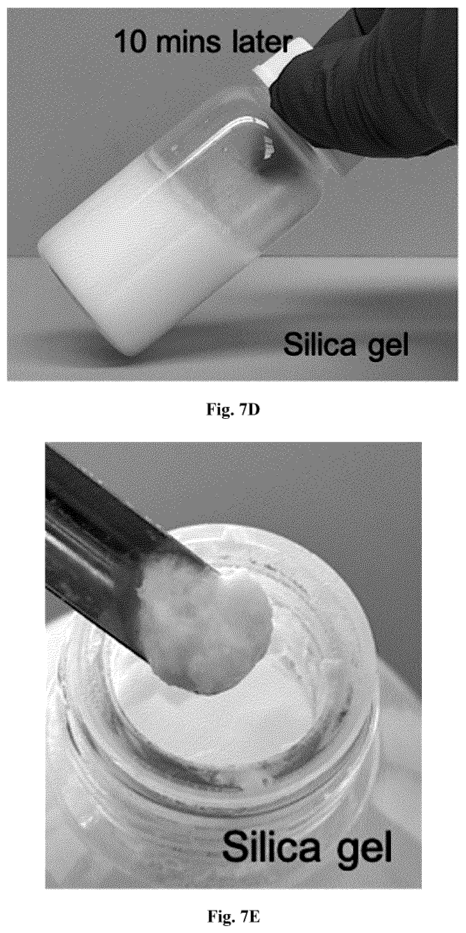

In the fabrication of hollow silica structures, templates serve as an indispensable factor for constructing hollow architectures. Previous studies have predominantly employed hard-templating methods using PS spheres or carbon spheres as cores, as well as soft-templating approaches utilizing surfactants or block copolymers as structure-directing agents. However, these conventional methods are often limited by low yields, complex processing procedures, and face challenges in cost-effectiveness and environmental sustainability for large-scale production. To address these limitations, an innovative strategy utilizing bubbles as templates for a novel synthetic route was developed (FIG. 1A). Specifically, the synthesis involves initially dispersing CTAB surfactant in solution, followed by a bubble templating process where CTAB molecules self-assemble into ordered structures on the bubble surface. Subsequently, during the sol-gel process, TEOS is introduced as a silica precursor to undergo hydrolysis and condensation reactions on the bubble surface, forming a well-ordered silica network. Finally, ambient drying removes the solvent, yielding hollow spherical silica powders. This approach not only simplifies the fabrication process but also effectively circumvents the template removal challenges that have long plagued hollow silica synthesis. This bubble-templated synthesis approach exhibits significant advantages in terms of scalability and efficiency. The photograph in FIG. 1B clearly shows the large-scale production capability, where 5 L uniform milky-white silica gels were successfully prepared in lab, indicating the potential for industrial-scale manufacturing. Furthermore, FIG. 1C compares the synthesis time used for different templating methods. Traditional template such as using polystyrene spheres, micelles, or vesicular templates typically require 10-20 hours, even up to 50 hours. In stark contrast, this bubble-templating strategy significantly reduces the synthesis time to approximately 10 mins. Due to the fast gelation reaction and the absence of complex manufacturing requirements, such as high-temperature calcination or harsh chemical etching processes, this synthesis route proves to be both cost-effective and easily scalable compared to the commonly adopted synthesis routes for hollow silica. The simple setup and straightforward procedure make it particularly attractive for industrial applications where large-scale production and time efficiency are crucial considerations. As illustrated in FIG. 7A, a typical fast synthesis process for hollow silica materials can be described as follows. First, CTAB surfactant is dispersed in solution, along with ammonia for pH adjustment and methylene for template fixation, resulting in a slightly turbid liquid containing silica precursors. After foaming treatment, a uniform milky silica slurry containing numerous bubbles is generated. The subsequent addition of TEOS initiates rapid gelation (requiring only ten minutes at room temperature), during which the milky slurry gradually solidifies into a homogeneous, non-flowing silica gel. FIG. 7B-7E compare the morphological evolution from slurry to gel state. The silica slurry appears as a milky, flowing liquid, while after 10 minutes, initial gelation produces a viscous, non-flowing state characterized by a white semi-solid texture. The final drying step removes solvents and residual water, yielding a white powder. SEM images (FIG. 1C) displays that the obtained as prepared hollow silica was consisted of dispersed spheres. It was found that the particle size was mostly in the range of 500-1200 μm. FIG. 1D shows that all the particles were hollow spheres. It is interesting that all the hollow spheres possess uniform shell thickness of ~40 nm, independent of their sizes. FIG. 1E exhibits a well-defined spherical structure with uniform hollow interior, which contributes to its ultra-low density. The high-magnification SEM image of the surface of hollow silica sphere, which indicating it was composed of silica nanoparticles about 10 nm and even smaller. FIG. 1F shows the representative transmission electron microscopy (TEM) image of as-prepared hollow silica with oriented mesoporous shell structures and hollow cavity. This distinctive structural feature results in an exceptional thermal insulation performance, as illustrated in Figure G. Compared to other aerogels such as SiC, graphene, carbon, PU foam, and cellulose aerogels, this material achieves a remarkable combination of low thermal conductivity (~0.02 W/mK) and low density (~100 kg/m³), making it particularly promising for practical thermal insulation applications.

### Example 2. Composition Principle and Characterization of Hollow Silica

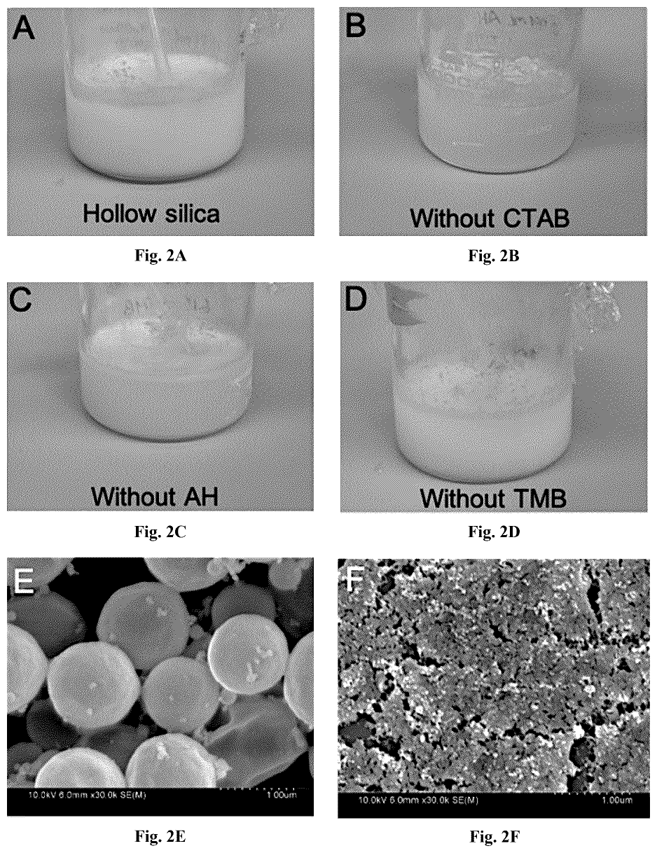

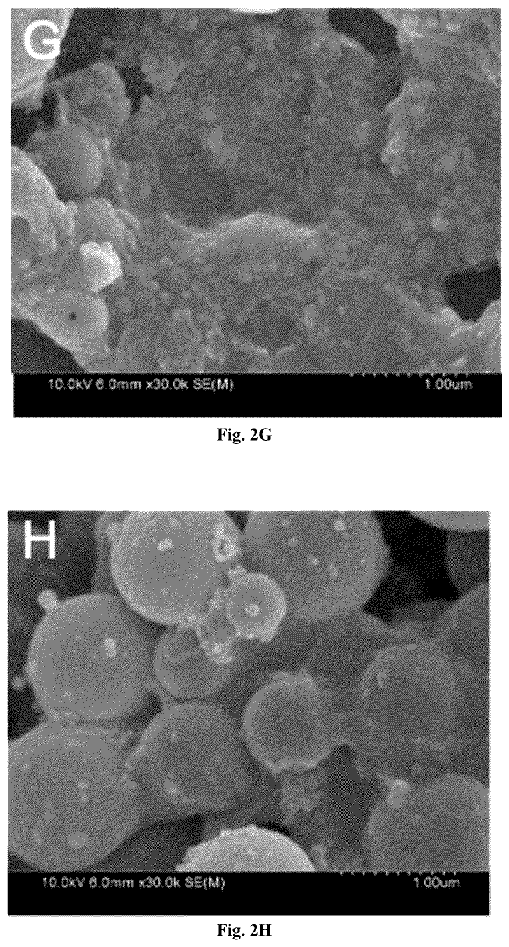

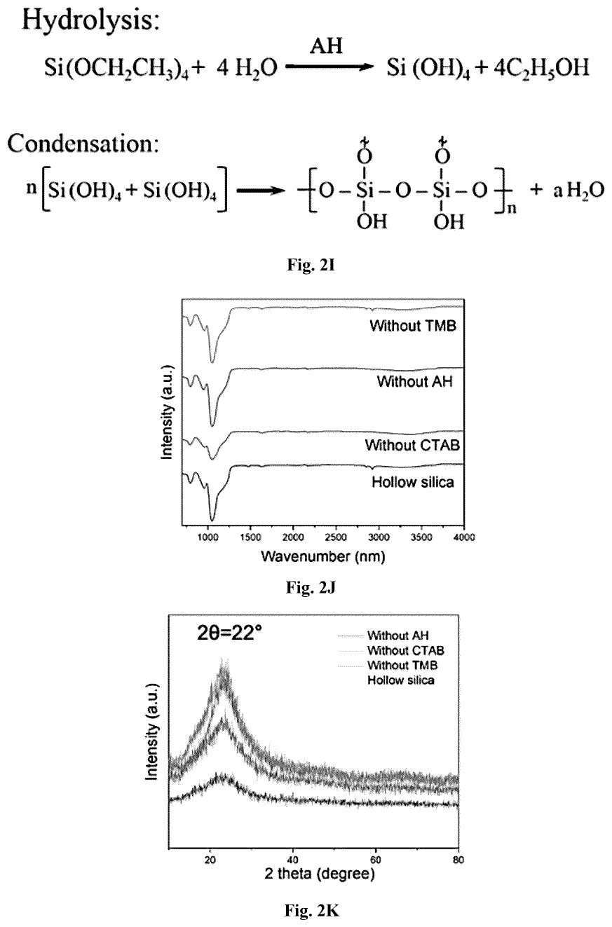

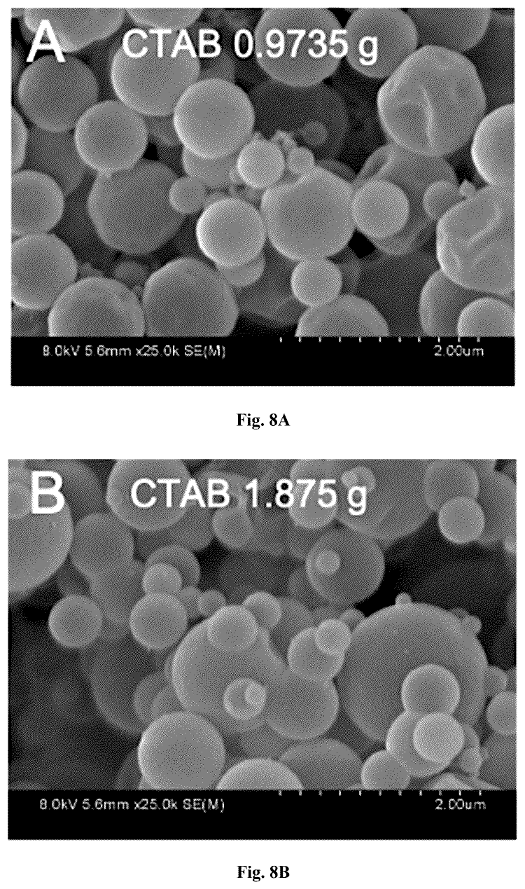

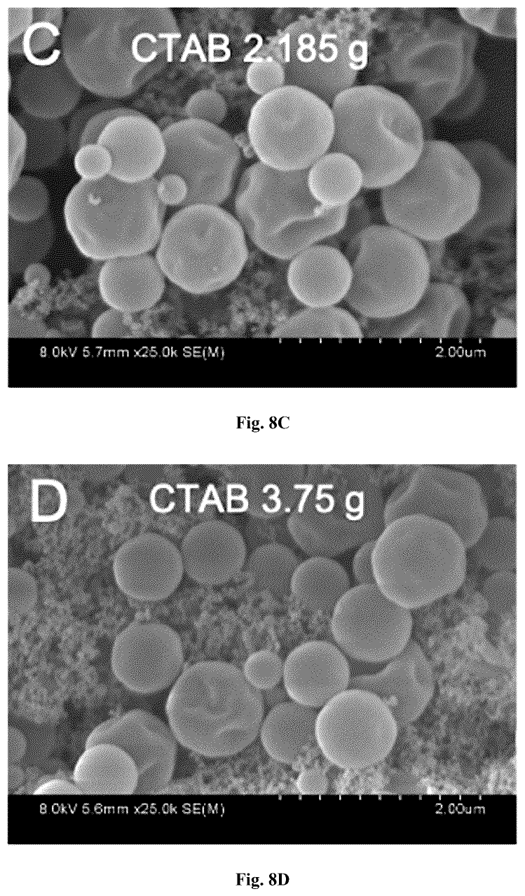

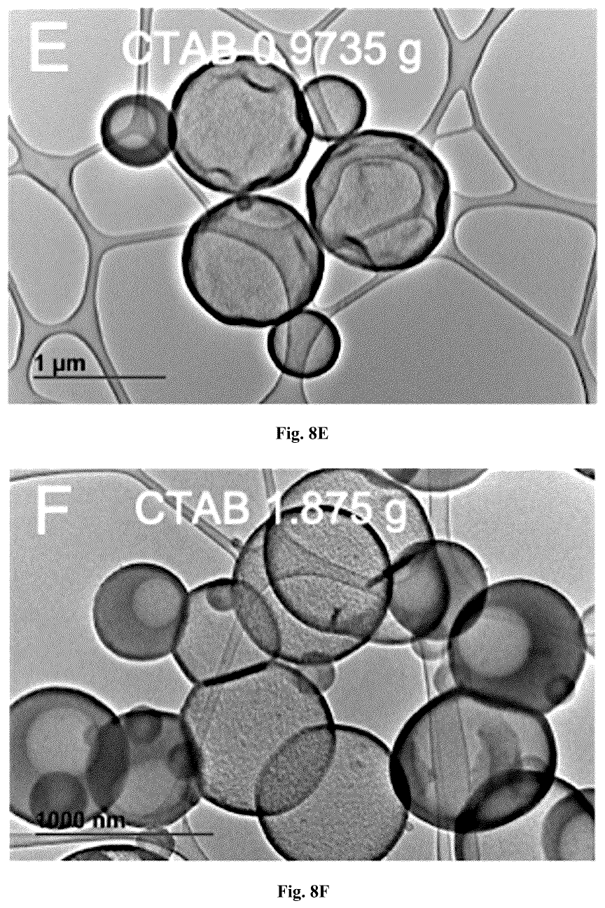

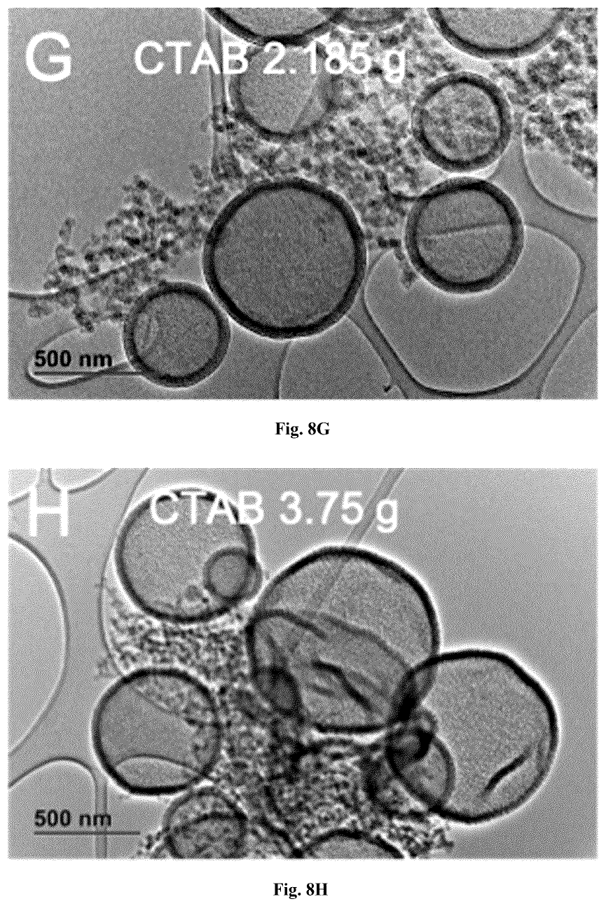

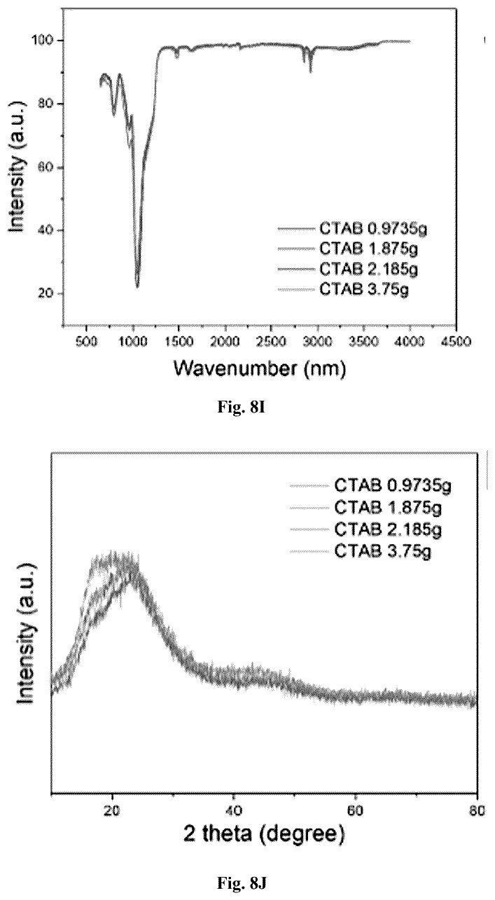

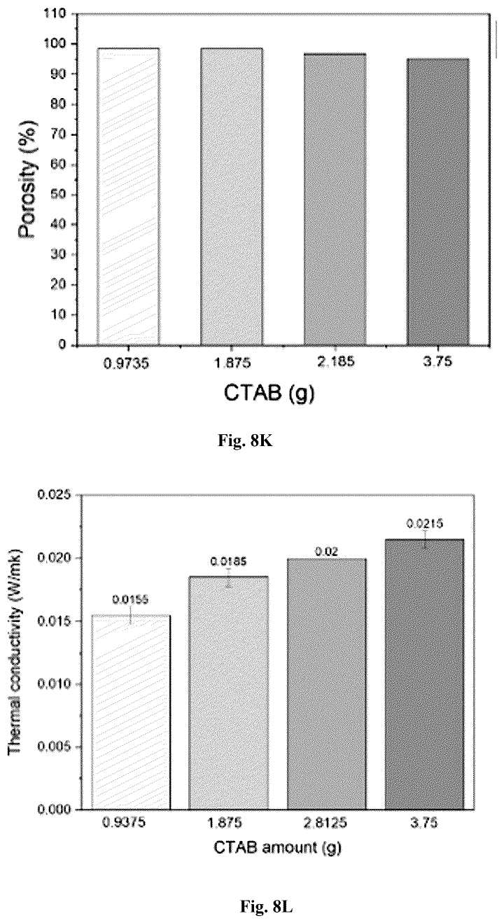

To elucidate the formation mechanism and the role of each component in hollow silica synthesis, a series of control experiments were conducted (FIG. 2). The standard synthesis with all components (FIG. 2A, 2E) yielded a white semi-solid gel with stable structural integrity. The SEM images (FIG. 2E) shows well-defined hollow silica spheres with uniform morphology were successfully obtained. In contrast, the system without CTAB (FIG. 2B) remained in a liquid state with a slightly turbid appearance. The SEM images (FIG. 2F) reveal that, in the absence of CTAB, which acts as a surface-active template, the particles exhibit irregular, aggregated morphologies and lack of hollow formation. Furthermore, the influence of CTAB dosage on the morphology and properties of hollow silica spheres was investigated. SEM and TEM characterizations (FIG. 8A-8H) revealed that at low CTAB content (0.9735 g), the obtained samples exhibited regular spherical hollow structures with good dispersion. As the CTAB amount increased to 3.75 g, the morphology of hollow silica spheres gradually became irregular, and the number of incomplete silica particles significantly increased, suggesting that excessive CTAB might interfere with the ordered self-assembly process of silica precursors. FTIR spectra (FIG. 8I) showed characteristic Si—O—Si stretching vibration peaks at around 1100 cm⁻¹ for all samples, while XRD patterns (FIG. 8J) displayed broad diffraction peaks in the 2θ range of 20-25°, confirming the typical amorphous silica structure of all samples. These results indicate that samples synthesized under different CTAB dosages exhibited similar characteristic peaks, suggesting that CTAB content only affects the morphology of the product without significantly influencing the chemical composition of silica. With increasing CTAB content, the porosity of the materials slightly decreased from approximately 95% to 90% (FIG. 8K), indicating that the hollow structure was maintained; meanwhile, the thermal conductivity increased from 0.015 W/(m·K) to 0.0215 W/(m·K) (FIG. 8L), which might be attributed to the irregular spherical structure and the increased number of incomplete particles. These findings demonstrate that precise control of CTAB dosage is crucial for obtaining ideal hollow silica spherical structures. Without AH (ammonia hydroxide (AH), which acts as a catalyst for hydrolysis reaction, the formation of spherical structures was significantly hindered, leading to poorly defined morphology (FIG. 2C, 2G). Similarly, the removal of TMB (trimethylbenzene) from the reaction system affected the structural integrity of the hollow spheres (FIG. 2D, 2H), indicating its crucial role in stabilizing the bubble template. The formation mechanism can be understood through the hydrolysis and condensation reactions of TEOS (FIG. 2I). The hydrolysis of TEOS is catalyzed by AH, producing Si(OH)4 intermediates, which subsequently undergo condensation to form Si—O—Si networks. This process was further confirmed by FTIR spectroscopy (FIG. 2J), where characteristic peaks corresponding to Si—O—Si bonds were observed. Additionally, XRD patterns (FIG. 2K) reveal the amorphous nature of the resulting silica structure, with a broad peak centered at 2θ=22°. The influence of AH addition on the formation and morphology of silica gel was also investigated. With the addition of AH, the pH of the reaction system increased to approximately 10, resulting in well-dispersed spherical silica particles with uniform size distribution. The high-magnification SEM image reveals the silica particles exhibit uniform, spherical shapes with smooth surfaces, indicating effective control over the synthesis process. The higher pH (~10) accelerates the hydrolysis of TEOS and the condensation of silica, promoting the formation of well-defined hollow structures. In contrast, when no AH was added, the reaction system maintained a neutral pH (~7), the hydrolysis and condensation of TEOS proceed more slowly, leading to irregular silica spheres and large amount SiO₂ particles significant aggregation, suggesting poor control over the synthesis. The distinct morphological differences between these two conditions suggest that the alkaline environment created by AH addition helps to achieve the desired reaction conditions for effective particle formation and stabilization.

Furthermore, the effect of TMB on the morphology of hollow silica spheres was investigated. SEM images (FIG. 2H) without TMB although spherical structures could still be formed with CTAB as the sole template, the particles showed relatively rough surfaces with irregular morphology under high magnification SEM. CTAB possesses a long hydrophobic chain and a hydrophilic ammonium head group, while TMB contains a benzene ring with three methyl substituents. The interaction between the hydrophobic chain of CTAB and the aromatic ring of TMB could enhance the stability of the micelle structure, while the methyl groups of TMB might provide additional steric hindrance to regulate the assembly process. These cooperative interactions between CTAB and TMB could lead to more ordered micelle formation, which ultimately results in more uniform and smooth hollow silica spheres. The formation mechanism was further verified through spectroscopic analysis. The reaction pathway proceeds through two main steps (FIG. 2I): (1) the hydrolysis of TEOS catalyzed by AH, producing Si(OH)4 intermediates, and (2) the subsequent condensation reaction forming Si—O—Si networks. The chemical composition and structural characteristics of the samples were further investigated by FTIR spectroscopy and XRD analysis (FIG. 2J, 2K). The FTIR spectra reveal characteristic absorption bands of silica network in all samples. Specifically, the complete hollow silica sample shows distinct peaks at around 1080 cm⁻¹ corresponding to the asymmetric stretching vibrations of Si—O—Si bonds, while the band at approximately 950 cm⁻¹ can be attributed to Si—OH stretching. The absorption intensities and peak positions vary among different samples, reflecting the impact of each component on the silica network formation. Notably, the sample without CTAB shows weaker absorption intensity, indicating less developed silica framework structure. The XRD patterns (FIG. 2K) exhibit a broad peak centered at 2θ=22°, which is characteristic of amorphous silica. The relatively higher intensity and better-defined peak of the complete hollow silica sample suggests a more ordered local structure compared to the control samples. This systematic study demonstrates that the successful synthesis of hollow silica spheres relies on the synergistic effects of CTAB-stabilized bubbles, AH-controlled hydrolysis, and TMB-assisted template fixation.

### Example 3. Effects of CTAB/TEOS Molar Ratio on the Structure and Properties of Hollow Silica

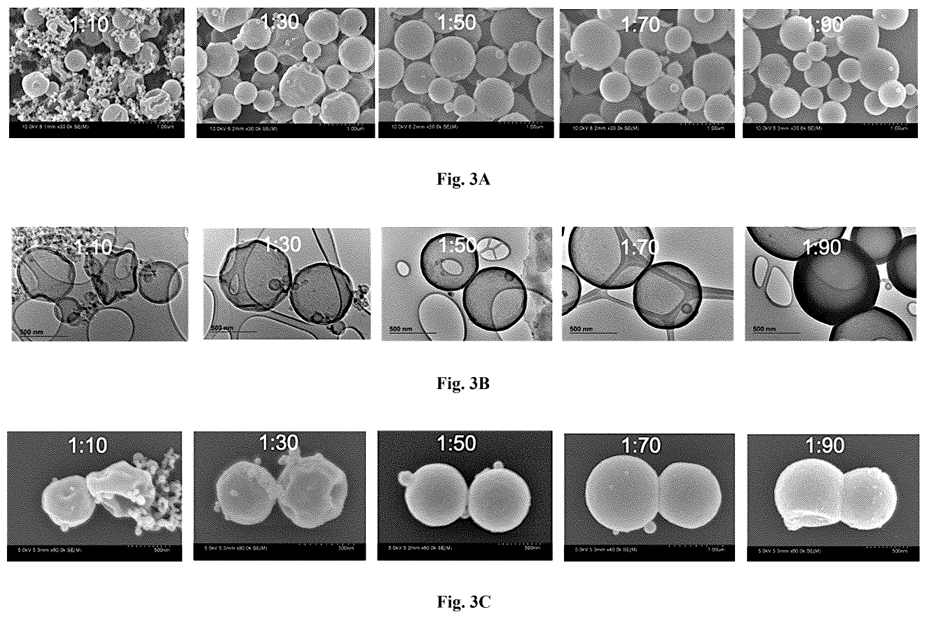

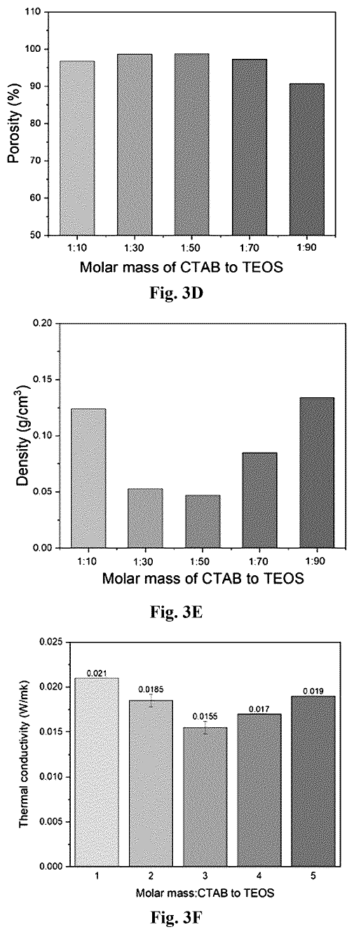

Further the controllable preparation of systematically examined the effects of CTAB to TEOS molar ratio on morphology and performance of hollow silica was explored. FIG. 3A demonstrate that the CTAB/TEOS molar ratio significantly influences the structural characteristics of the hollow silica. It can be observed that at a molar ratio of 1:10, the product simultaneously exhibits irregular large spherical structures and fine spherical particles, showing obvious size non-uniformity. As the TEOS proportion increases, the fine particles gradually disappear, the particle size distribution narrows, sphericity gradually improves, and particle size tends to become more uniform. From TEM and SEM images (FIGS. 3B, 3C), it is observed that the CTAB/TEOS molar ratio significantly influences the connectivity between particles: at a ratio of 1:10, large hollow silica particles exhibit irregular morphology with evident aggregation of smaller hollow silica particles around them; as the ratio increases to 1:30, particles gradually become more rounded with reduced interconnection between spherical particles; at a ratio of 1:50, particles achieve complete separation, forming independent and regular spherical structures; when the ratio further increases to 1:70 and 1:90, although the particle surfaces become smoother and denser, the shared edges between particles gradually intensify, particularly evident at the 1:90 ratio. The potential mechanisms for the morphological influence of CTAB to TEOS ratio are as follows: At low TEOS ratios, the higher CTAB concentration leads to strong micelle interactions, promoting particle aggregation and irregular growth; as the TEOS ratio increases, the relative CTAB concentration decreases, weakening micelle interactions, while moderate silica source concentration (1:50) ensures uniform shell growth, forming regular independent spherical structures; however, when TEOS ratio becomes too high (1:70-1:90), local supersaturation of silica source promotes bridging growth between particles, and under surface tension effects, excessive silica growth tends to form bridges at particle contact points to minimize system surface energy, resulting in intensified shared edges. This indicates that the 1:50 molar ratio achieves the optimal balance of various forces, making it the ideal condition for obtaining fully dispersed hollow spherical structures. Further, the characterization of structural features was conducted through particle size and pore structure analysis. With the variation of CTAB/TEOS ratio, the average particle size exhibits a trend of initial decrease followed by an increase: from 1:10 to 1:50, the particle size significantly decreases from 1780 nm to 1095 nm, then gradually increases to 1663 nm as the ratio increases to 1:90. Nitrogen adsorption-desorption tests of the 1:10 ratio sample show a typical type IV isotherm with a distinct hysteresis loop at relative pressure P/P0 of 0.6-0.8, indicating capillary condensation phenomenon and mesoporous structural characteristics, with a high BET surface area of 1339 m²/g. The corresponding pore size distribution curve reveals a sharp peak at approximately 10 nm, demonstrating uniform mesoporous structure with concentrated pore size distribution. FIG. 3D shows the porosity changes with different CTAB/TEOS molar ratios show an initial increase followed by a decrease trend. The porosity increases from 1:10 to reach its peak at 1:50 (approximately 98%), and then gradually decreases to about 90% at ratios of 1:70 and 1:90. The density variation (FIG. 3E) exhibits an opposite trend to porosity. Starting from a relatively high value at 1:10 (about 0.12 g/cm³), it decreases to reach its minimum (approximately 0.05 g/cm³) at ratios of 1:30 and 1:50, then gradually increases again, reaching its highest value (about 0.13 g/cm³) at 1:90. FIG. 3F shows the thermal conductivity fluctuates within the range of 0.015-0.021 W/mK. It shows a decreasing trend from 1:10 to 1:50, reaching its lowest value of about 0.0155 W/mK at 1:50, followed by a slight increase as the ratio increases to 1:70 and 1:90. These results indicate that a CTAB/TEOS molar ratio of 1:50 yields optimal comprehensive properties: highest porosity, low density, and low thermal conductivity, which corresponds well with the previously observed morphological characteristics and demonstrates the material's promising potential for thermal insulation applications.

### Example 4. Thermal Conductivity Numerical Simulations of Hollow Silica

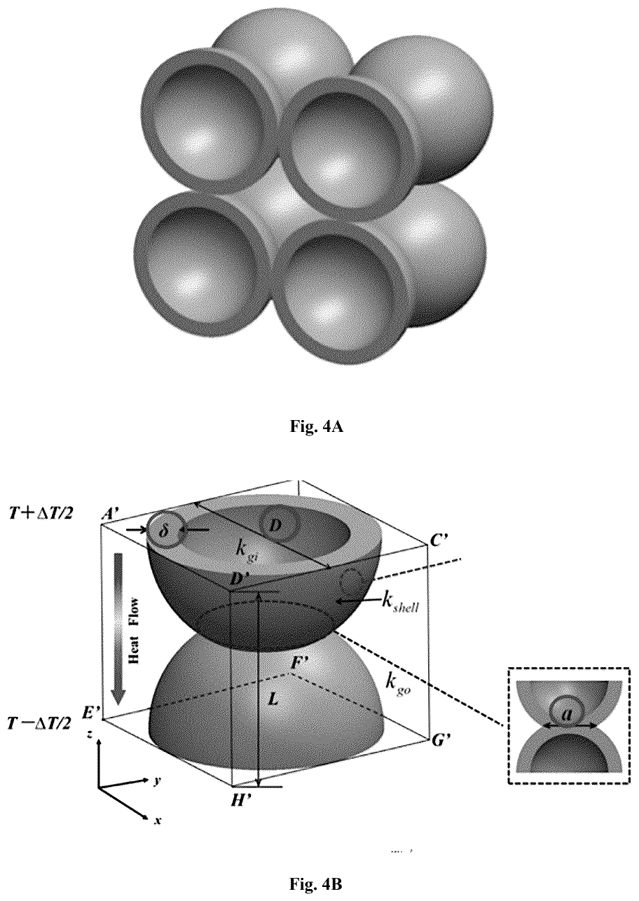

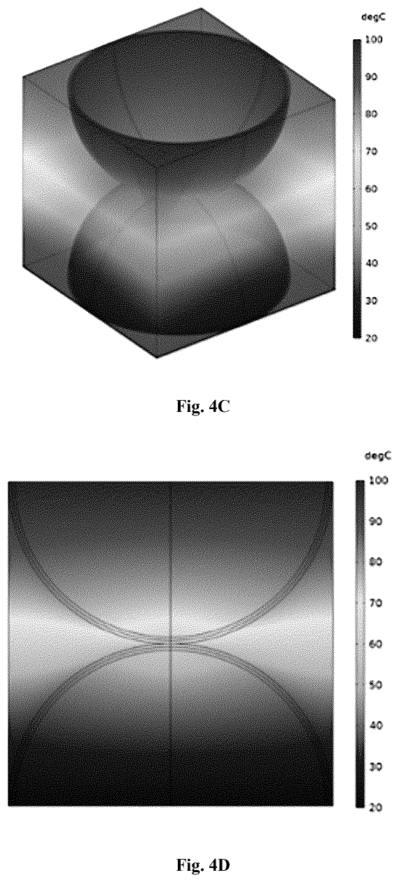

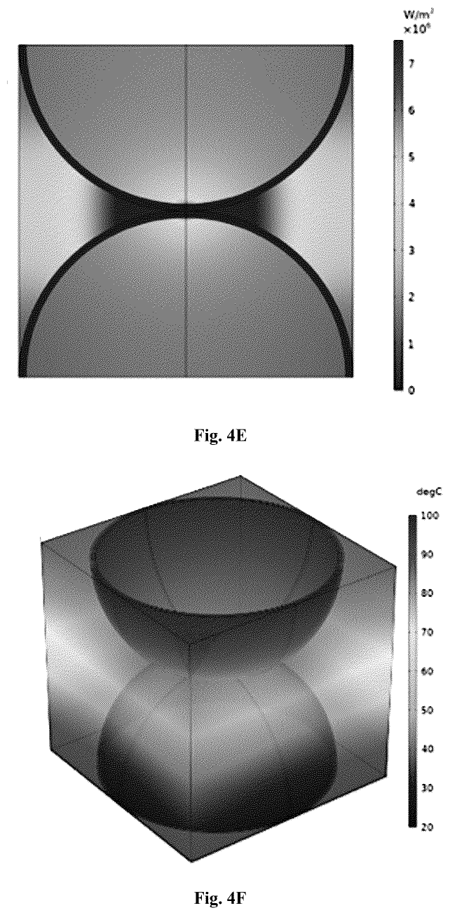

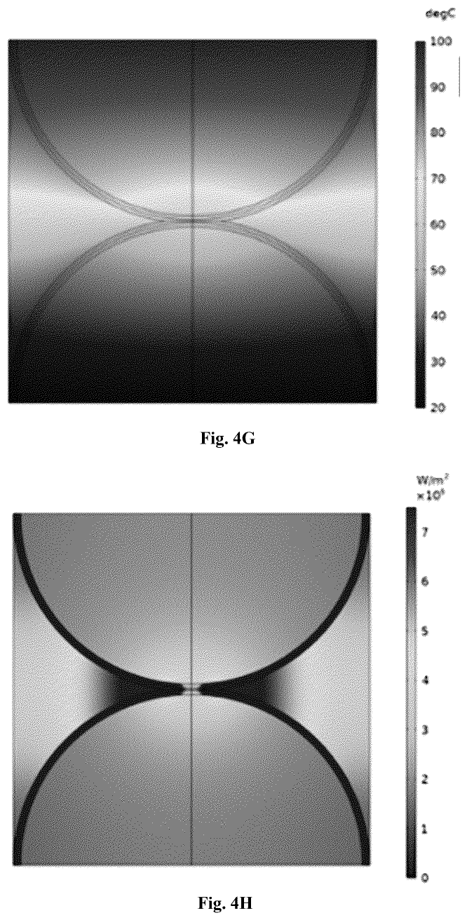

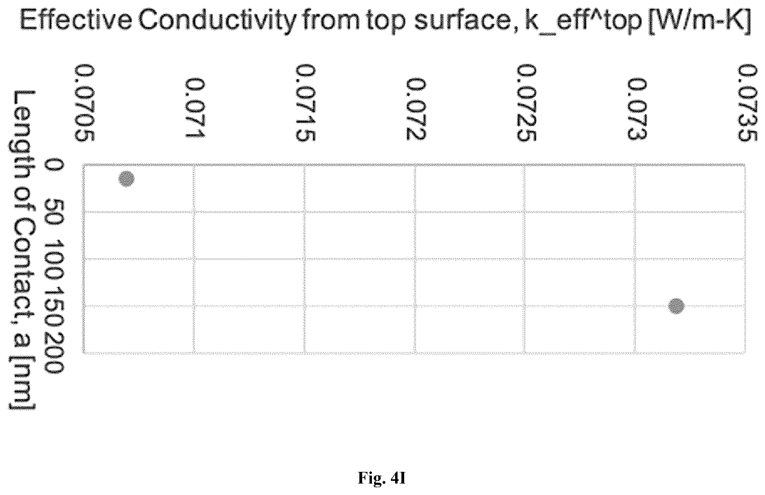

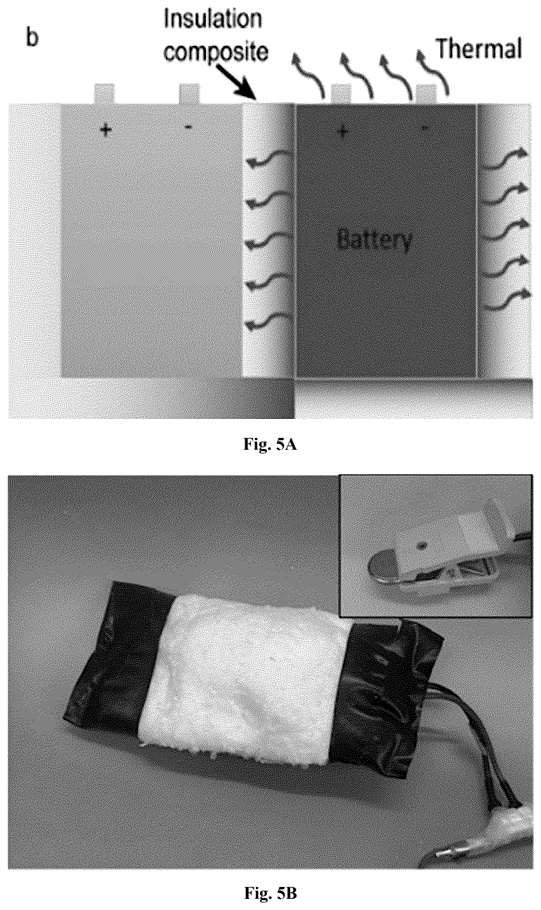

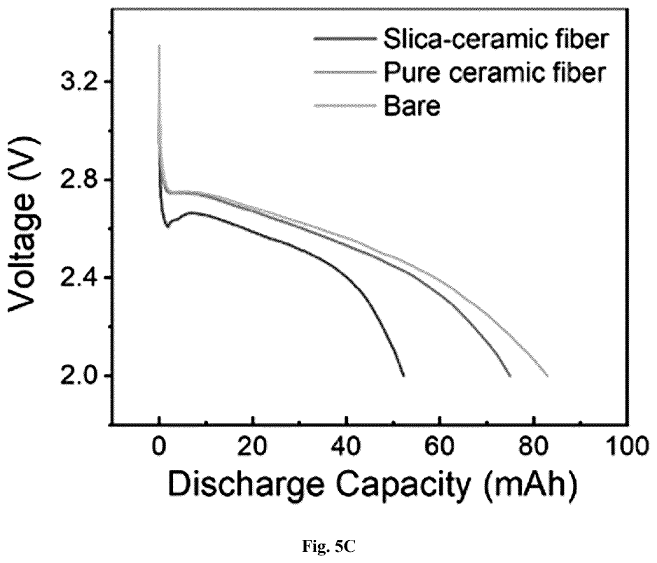

Based on the numerical simulation results, the effect of contact length on the thermal conductivity of hollow silica spheres was investigated. The model consists of two hollow spheres in contact, with key parameters including shell thickness (k_shell), contact length (a), and temperature gradient (ΔT) (FIGS. 4A-4B). Temperature distribution maps (FIGS. 4C-4H) reveal that heat primarily conducts through the contact region between spheres, forming distinct temperature gradients at the neck area. Quantitative analysis (FIG. 4) demonstrates that the effective thermal conductivity increases from 0.0707 to 0.0732 W/m·K as the contact length extends from 0 to 150 nm. This enhancement can be attributed to the enlarged contact area providing more efficient heat conduction pathways and reduced interfacial thermal resistance. The findings suggest that optimizing contact characteristics between hollow spheres can effectively improve the thermal transport properties of such nanostructured materials.

### Example 5. Battery Thermal Management

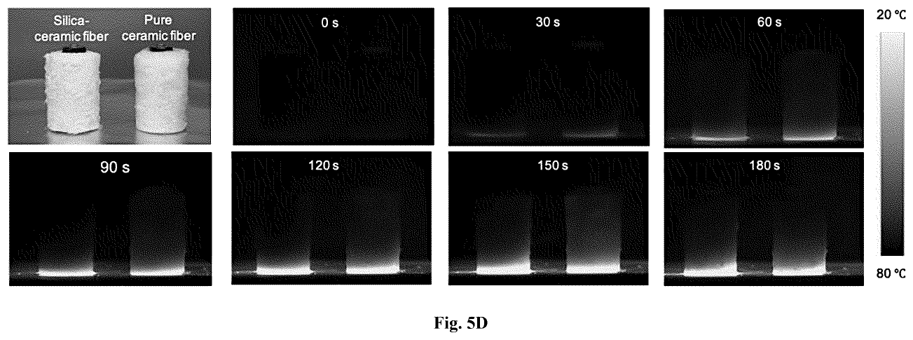

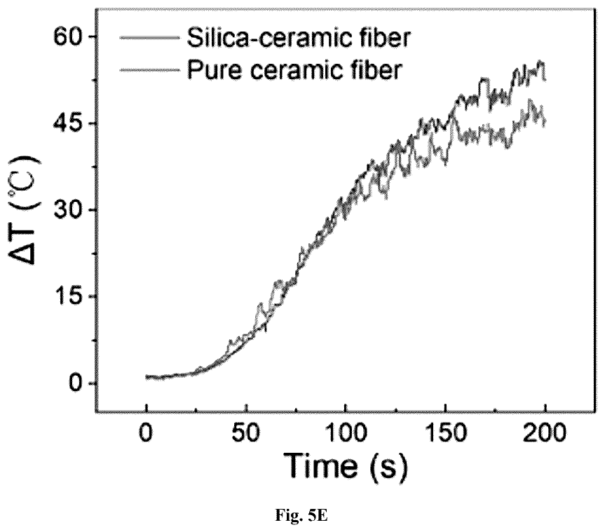

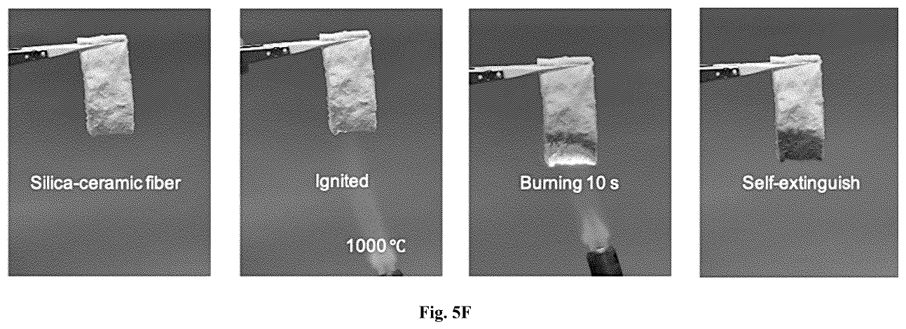

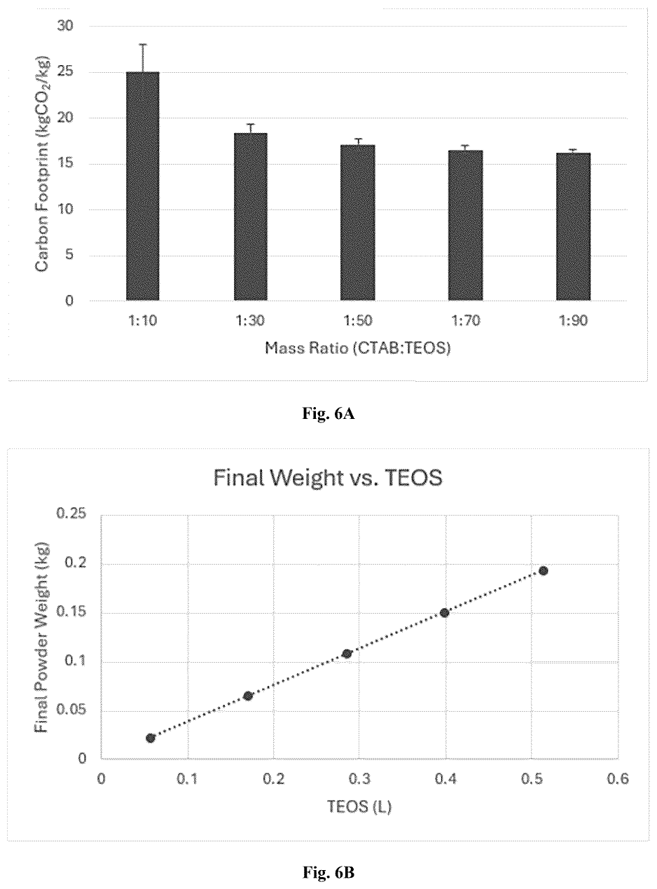

Local thermal hotspots generated by thermal runaway or combustion incidents can induce structural deterioration in battery components, presenting significant challenges for thermal management systems in applications ranging from wearable devices and smartphones to electric vehicles. Given the susceptibility of lithium-ion batteries to thermal runaway under elevated temperatures or abuse conditions, developing efficient thermal insulation materials to suppress heat transfer and mitigate thermal runaway risks is of paramount importance (FIG. 5A). Leveraging the superior thermal insulation properties of hollow spheroidal aerogels, a facile impregnation protocol was developed wherein ceramic fiber matrices were immersed in hollow silica gel and subsequently dried to yield ceramic fiber-silica composites. The ceramic fiber framework exhibits excellent thermal stability; however, its inherent high porosity results in elevated thermal conductivity, thereby limiting its insulation efficacy. The incorporation of hollow silica gel as a filling phase substantially reduces the composite's thermal conductivity and enhances its thermal insulation capabilities. The SEM images of silica-ceramic fiber bat revealed an interconnected porous architecture in the pure ceramic fibers. The interfacial characterization of the composite demonstrated uniform SiO₂ coating on the ceramic fiber surfaces, forming an insulation structure. Thermal conductivity measurements confirmed that the composite material exhibited significantly lower thermal conductivity compared to pure ceramic fibers, validating its enhanced thermal insulation performance. To evaluate the practical viability of this composite material, it was implemented as an external battery coating and conducted comprehensive assessments to verify its compatibility with complex battery architectures (FIG. 5B). The material's thermal insulation properties were evaluated by subjecting batteries to elevated temperatures, simulating external thermal variations. Results (FIG. 5C) indicated that increased internal temperatures led to enhanced internal resistance, resulting in higher overpotential and diminished discharge capacity. Batteries incorporating this thermal insulation material demonstrated the highest overpotential and lowest discharge capacity, indicating effective suppression of heat transfer to the battery interior and reduced environmental thermal impact. In contrast, uncoated batteries exhibited the lowest discharge capacity and highest overpotential, underscoring the effectiveness of this thermal insulation design in mitigating external thermal influences. To quantitatively assess the thermal insulation performance, infrared thermal imaging was employed to monitor real-time temperature distribution during heating processes and compared the insulation efficacy between silica-ceramic fiber composites and pure ceramic fibers (FIG. 5D). The SiO₂-ceramic fiber coated samples exhibited markedly slower temperature elevation under continuous heating, confirming superior heat transfer inhibition. (FIG. 5E) Temperature profile analysis revealed minimal temperature increases in the SiO₂-ceramic fiber samples, consistent with their reduced thermal conductivity, effectively retarding heat diffusion and enhancing battery safety. Considering potential exposure to extreme conditions, the material's fire resistance was evaluated. (FIG. 5F) Combustion tests conducted at 1000 °C demonstrated that silica-ceramic fiber composites exhibited self-extinguishing properties after 10-second flame exposure, while pure ceramic fibers lacked this characteristic, indicating that silica incorporation significantly enhanced the material's fire resistance. In conclusion, the developed silica-ceramic fiber composite demonstrates not only exceptional thermal insulation properties but also provides enhanced safety protection under extreme temperature conditions, presenting promising applications in thermal management and thermal runaway protection for lithium-ion batteries.

### Example 6. Environmental Impact of Hollow Silica

Life cycle assessment (LCA) and yield analysis are crucial factors in determining the feasibility and sustainability of aerogel for thermal insulation applications. To promote sustainable development and evaluate the environmental impact of hollow silica, life cycle assessment (LCA) and yield analysis of different formulations was conducted. The carbon footprint (measured as kg CO2/kg) shows a decreasing trend with increasing TEOS proportion: the highest environmental impact is observed at 1:10 ratio (approximately 24 kg CO2/kg), which then significantly decreases to about 18 kg CO2/kg at 1:30 ratio, and further stabilizes around 16-17 kg CO2/kg for ratios from 1:50 to 1:90. In terms of product yield, a linear relationship between the final product weight and TEOS volume is observed, with the yield increasing proportionally from 0.02 kg to 0.19 kg as TEOS volume increases from 0.1 L to 0.5 L, indicating a consistent and predictable production efficiency across different TEOS concentrations. This analysis provides crucial insights into the environmental impact and production efficiency of hollow silica microspheres for their practical application in thermal insulation building materials.

### Example 7. Conclusion

In summary, a rapid and efficient soft-template method for synthesizing hollow silica microspheres, with CTAB/TEOS molar ratio serving as a critical parameter in controlling their structure and properties was successfully developed. Systematic investigation revealed that a CTAB/TEOS ratio of 1:50 yields optimal performance, featuring regular spherical morphology, uniform size distribution, and ideal particle separation. The microspheres synthesized under these conditions exhibit exceptional characteristics including high porosity (98%), low density (0.05 g/cm³), and ultralow thermal conductivity (15.5 mW·m⁻¹·K⁻¹). Notably, the synthesis can be completed within 10 minutes under ambient conditions, representing a significant advancement over traditional time-consuming aerogel preparation methods. The material also demonstrates favorable environmental performance, with carbon footprint decreasing from 24 to 16 kg CO2/kg as TEOS proportion increases, while maintaining consistent and predictable production yields. These comprehensive results demonstrate the potential of this approach for scalable, sustainable production of high-performance thermal insulation materials, offering promising solutions for applications in buildings, transportation, and aerospace sectors where thermal management is crucial.

All publications mentioned herein are incorporated by reference to the extent they support the present invention.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.

We claim:

1. A hollow silica material, said material comprising hollow silica spherical particles, wherein said particles are in the form of microspheres, wherein said material is free of nanoporous silica particles and free of polymers.

2. The hollow silica material of claim 1, wherein said hollow sphere particles are about 50 μm to about 1200 μm.

3. The hollow silica material of claim 1, wherein said hollow sphere particle has a shell thickness of about from 20 nm to 100 nm.

4. The hollow silica material of claim 1, wherein said hollow sphere particles have a thermal conductivity of about 10 mW/mK to about 25 mW/mK.

5. The hollow silica material of claim 1, wherein said hollow sphere particles have a density of about 100 kg/m³ to about 800 kg/m³.

6. The hollow silica material of claim 1, wherein said hollow sphere particles have a porosity of about 70% to about 98%.

7. The hollow silica material of any of the preceding claims, wherein said hollow sphere particles are used as insulation materials.

8. The hollow silica material of any of the preceding claims, wherein said material further comprises a surfactant.

9. A method of making hollow silica material of any of the preceding claims, said method comprising preparing the hollow silica particles using bubble templates.

10. The method of claim 9, wherein said method comprises:
a. Combining an aqueous cationic surfactant with a base and methylene to obtain a silica precursor solution;
b. Bubble templating said silica precursor solution by foaming treatment to obtain a silica slurry;
c. Adding TEOS, TMOS, or water-glass to said silica slurry to obtain a semi-solid silica gel; and
d. Drying said semi-solid silica gel until said silica gel solidified into a non-flowing silica gel comprising hollow silica particles.

11. The method of claim 10, wherein said surfactant is chosen from cetyltrimethylammonium bromide (CTAB), sodium dodecyl sulfate (SDS), sodium lauryl sulfate (SLS), sodium stearate, benzalkonium chloride (BAC), or cetrimonium chloride.

12. The method of claim 10, wherein said base is chosen from ammonia, NaOH, KOH, Na₂CO₃, Ca(OH)₂.

13. The method of claim 10, wherein said semi-solid silica gel is dried at room temperature for about 1 minute to about 10 minutes.

14. The method of any of the preceding claims, steps (a)-(d), wherein said method occurs in about 1-10 minutes.

15. The method of any of the preceding claims, wherein said method produces about 1 L to about 10 L of a silica aerogel solution.

16. The method of any of the preceding claims, wherein semi-solid silica gel is formed in less than 10 minutes.

17. The method of any of the preceding claims, wherein said method involves one-pot synthesis of said hollow silica particles.

18. An insulation material comprising a material of any of the preceding claims.

19. A battery, said battery comprises a material of any of the preceding claims.
